(19) United States
(12) Patent Application Publication
(10) Pub. No.: US 2022/0055808 A1
(43) Pub. Date: Feb. 24, 2022

(54) Beverage Container With Cryogenic Additive Sequestration and Aeration

(71) Applicants: Kevin D. McGushion, Simi Valley, CA (US); Michelle Kristen Barrett, Los Angeles, CA (US)

(72) Inventors: Kevin D. McGushion, Simi Valley, CA (US); Michelle Kristen Barrett, Los Angeles, CA (US)

(21) Appl. No.: 17/411,037

(22) Filed: Aug. 24, 2021

Related U.S. Application Data
(60) Provisional application No. 63/069,334, filed on Aug. 24, 2020.

(51) Int. Cl. B65D 51/28; B65D 17/28; B65D 85/73; B65B 61/20

(52) U.S. Cl. CPC B65D 51/2807; B65B 61/20; B65D 85/73; B65D 17/4012

(57) ABSTRACT

The present specification discloses an insert for a fluid product container that provides one or optionally both of a fluid aeration insert, that aerates the fluid product during the pour, and a cryogenic additive insert, that protects the fluid product container from exposure to the extreme low temperatures of a cryogenic additive, such as liquid nitrogen, that can cause damaging interaction with the container lining that exposes fluid product to the bare metal of the container, negatively affecting the flavor or safety of a beverage and/or causing structural damage to the container. The cryogenic additive insert provides a cryogenic additive tray having a cryogenic additive holding concavity that receives and hold a cryogenic additive during the filling process such that the cryogenic additive is isolated from the walls of the container. The fluid aeration insert includes a multiplicity of aeration openings through which the fluid product must flow during pouring.

This patent application claims the benefit of United States Provisional Patent Application Ser. No. 63/069,334, entitled “Aeration and Additive Isolation Assembly,” filed Aug. 24, 2020, which application is incorporated in its entirety here by this reference.

### BACKGROUND

The subject of this patent application relates generally to aeration and additive devices and methods, and more particularly to aeration devices for introducing oxygen into a fluid within a container and to devices for introducing additives for the displacement or removal of oxygen and/or pressurization of the container.

By way of background, some beverages, such as wine, whiskey, etc., are aerated (i.e., air containing oxygen is brought into contact with the beverage) for the purpose of reducing the bitterness caused by tannins, in for example young wines, by oxidizing and evaporating these undesirable and naturally occurring polyphenols. One of the primary methods of aerating wine is to pour the wine into a decanter to maximize liquid surface to air contact. Other methods include swirling the wine within a wine glass, pouring the wine back and forth between two containers, and even mixing the wine within a blender. These methods take time and require separate processes and/or equipment to achieve.

Further, in non-carbonated canning operations, such as the canning of beverages like wine, juices, teas, and the like, one or more additives are added directly to the container and the fluid product during (or adjacent in time to) filling. The additive changes state to a gas for the purpose of displacing oxygen and pressurizing the can to provide structural support of the can (such as a standard aluminum can or the like). An additive commonly added to beverage within the can during canning is a cryogenic additive, such as liquid nitrogen. However, additive materials or secondary materials may cause damage to the container, especially the inner wall, due to the extreme low temperatures of the material, the pH of the material, the temperature of the material, the abrasive nature of the material, and/or other deleterious qualities of the material.

In one example filling procedure, in canning operations, such as the canning of beverages (e.g., wine, juice, energy drinks, etc.), one or more additives (such as a cryogenic additive) are added directly to the liquid beverage during (or near in time to) filling. The cryogenic additive changes state to a gas (i.e., by evaporation if liquid or sublimation if solid) for the primary purposes of pressurizing the container and displacing the oxygen. Once the lid is sealed in place, the additive continues to boil or sublimate to a gas, resulting in pressurized gas being trapped within the container for maintaining the structure of the container (such as a standard aluminum can or the like) for transport, storage, and for purchasing by the consumer.

However, the cryogenic additive contributes to an undesirable flavor to the beverage due to interactions between the cryogenic additive and protective coating (e.g., a polymer lining) on the container walls, and, afterwards the beverage's interaction with the damage caused by the cryogenic additive. The damage to the integrity of the protective coating exposes the bare aluminum underneath and permits the beverage to interact with the aluminum for an extended period of time. An acidic beverage (e.g., with a pH between 3 and 4), such as wine or certain juices, the chemical reaction between the exposed aluminum and the beverage can impart a “tinny” and/or sulfur taste and odor to the beverage. Further, depending on the beverage, storage time, and other factors, the structural integrity of the can be degraded, causing failure of the can. Damage to the protective coat may also cause undesirable interactions between the contained fluid and the wall, even when containing non-acidic fluids.

Means for automatic aeration and for preventing adverse reactions between the container and the cryogenic additive are therefore needed.

Aspects of the present invention fulfill these needs and provide further related advantages as described in the following summary.

### SUMMARY

Aspects of the present invention teach certain benefits in construction and use which give rise to the exemplary advantages described below.

The present specification discloses an insert for a container, the insert comprising a cryogenic additive tray having a cryogenic additive holding concavity configured to receive and substantially hold therein a cryogenic additive during the filling process such that the cryogenic additive is isolated from the inner wall of the container and is isolated from the fluid product after filling and with the container substantially upright and while the cryogenic additive is at the cryogenic temperature; wherein, during the filling process, the cryogenic additive is permitted to change state to a gas without substantially contacting the inner wall of the container while the cryogenic additive is at the cryogenic temperature.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present aeration container. In such drawings:

FIG. 1 is an exploded top perspective view of the present insert aligned and ready for insertion into a container, in accordance with at least one embodiment disclosed herein;

FIG. 2 is an assembled cross-sectional view of the insert within the container of FIG. 1;

FIG. 3 is a magnified assembled cross-sectional view of the insert within the container of FIG. 2;

FIG. 4 is a top view of the insert of FIG. 1;

FIG. 5 is a bottom view of the insert of FIG. 1;

FIG. 6 is a bottom perspective view of the insert of FIG. 1;

FIG. 7 is an exploded top perspective view of another embodiment of the present insert aligned and ready for insertion into a container, in accordance with at least one embodiment disclosed herein;

FIG. 8 is an assembled cross-sectional view of the insert within the container of FIG. 7;

FIG. 9 is a top view of the cryogenic additive insert of FIG. 7;

FIG. 10 is a top view of the cryogenic additive insert of FIG. 7;

FIG. 11 a top view of the fluid aeration insert of FIG. 7;

FIG. 12 a bottom view of the fluid aeration insert of FIG. 7;

FIG. 13 a side view of the fluid aeration insert of FIG. 7; and

FIG. 14 a bottom perspective view of the fluid aeration insert of FIG. 7.

The above-described drawing figures illustrate aspects of the present aeration container in at least one of its exemplary embodiments, which are further defined in detail in the following description. Features, elements, and aspects of the aeration container and components that are referenced by the same numerals in different figures represent the same, equivalent, or similar features, elements, or aspects, in accordance with one or more embodiments.

### DETAILED DESCRIPTION

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

The present specification discloses an insert for a fluid product container that provides one or optionally both of a fluid aeration insert, that aerates the fluid product during the pour, and a cryogenic additive insert, that protects the fluid product container from exposure to the extreme low temperatures of a cryogenic additive, such as liquid nitrogen, that can cause damaging interaction with the container lining that exposes fluid product to the bare metal of the container, negatively affecting the flavor or safety of a beverage and/or causing structural damage to the container. The cryogenic additive insert provides a cryogenic additive tray having a cryogenic additive holding concavity that receives and hold a cryogenic additive during the filling process such that the cryogenic additive is isolated from the walls of the container. The fluid aeration insert includes a multiplicity of aeration openings through which the fluid product must flow during pouring.

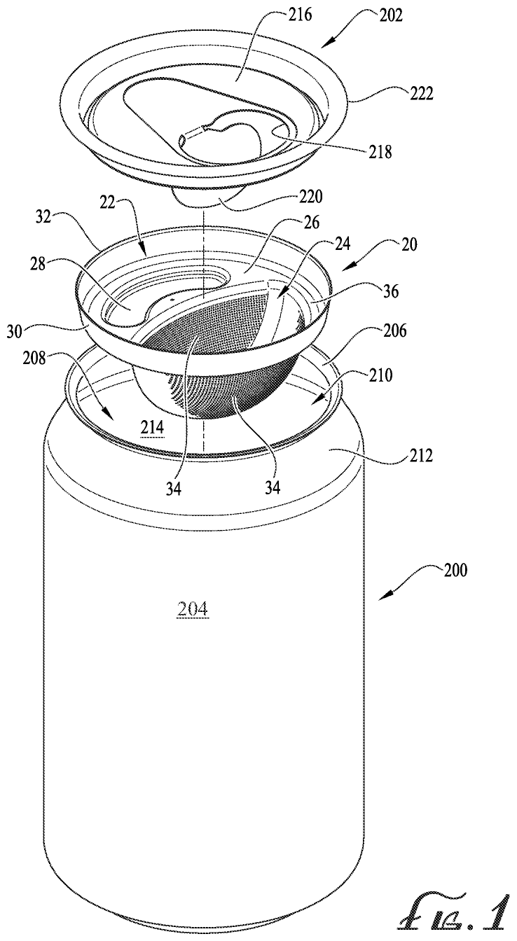

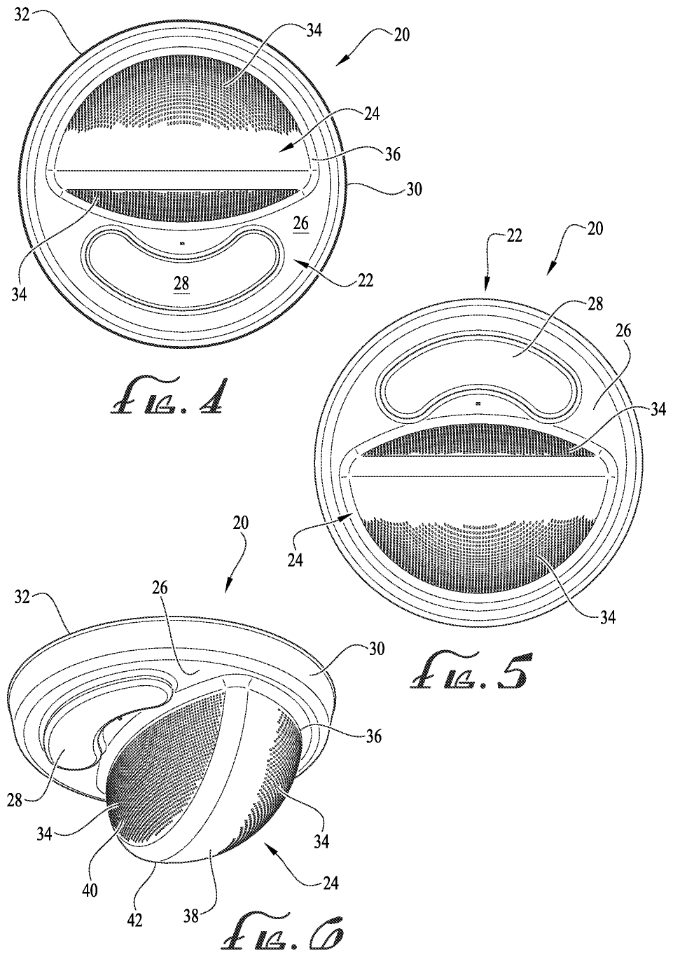

Referring first to FIGS. 1-6, an example embodiment of the present insert 20 (which may also be referred to herein as a container insert, a cryogenic additive isolation insert, a aeration insert, or an aeration and additive isolation insert, depending on the configuration of the insert 20) is illustrated aligned with a container 200 for storing therein a fluid product F, such as a beverage. The container 200 is a standard aluminum can used for storing beverages, such as sodas, fruit or vegetable juices, wines, spirits, beer, and so on. The present insert 20 is positionable within the interior 208 of the container 200, initially being held within the opening 218 of the container 200 due to flared upper edge 32 of the flange (or skirt) 30 resting supportively upon the rim 206 of the container 200, positioning the cryogenic additive isolation portion 22 and the aeration portion 24 beneath the rim 206 of the container 200, in one or more embodiments. The lid 202 is placed on top of the insert 20 and the container 200, with the lid flange 222 resting on top of the upper edge 32 of the insert 20 and the insert 20 resting on top of the rim 206.

The container 200 can be a standard aluminum can, such as a drink can, with no modification or at least some modification to accommodate the insert 20, which is configured to be inserted into the container 200 opening 218 and, in at least one embodiment, supported by the rim 206 until further processing, such as a seaming operation which curls and compresses a double seam as discussed further below. The container 200 includes a container body 204 that defines an interior space 210 therein for containing a fluid product F. Below the rim 206, the container body 204 includes an annular necked portion 212 which sizes the outwardly flared rim 206 to receive the upper perimeter edge 32 of the lid 202. The lid 202 can be a standard aluminum can lid, with no modification or at least some modification to accommodate the insert 20. The lid 202 includes a top wall 216 with a drink or dispensing opening 218 selectively pried open by a stay-on tab (not shown, but commonly known in industry) by applying pressure to the opening panel 220 (which will also be described herein as a tab or cantilevered tab) defined by a score line. Here, tab 220 is shown in the open position to illustrate the clearance provided by the depression 36 of the aeration portion 24, as described further below. It is understood therefore, that the tab 220 will not be opened during the canning process, and will remain sealed until the end user pries it open.

Looking further at the structure of the insert 20 embodiment of FIGS. 1-6, a sheet of material, such as thin aluminum, is stamped to form both the cryogenic additive isolation portion 22 and the aeration portion 24, as well as the container engagement portion comprising the flange 30 that extends upwardly (i.e., extending towards the lid 202 when the lid 202 is placed upon the insert 20 and the container 200) with the flared upper edge 32. The stamping process can be achieved in one or more steps, to further form the cryogenic additive holding concavity 28 and the depression 36.

The depression 36 is shaped, somewhat, like a half hemisphere that creates two opposing walls 38 and 40, where one or both walls of the depression 36 includes a plurality or a multiplicity of aeration openings 34. The shape of the depression 36 can be changed according to the design requirements, so long as at least a portion of the fluid product F flows through the multiplicity of aeration openings 34 when pouring the fluid product F. The multiplicity of aeration openings 34 ca be formed before or after the depression 36 is formed, by using known perforating techniques, such as laser perforating, die and punch perforating, etc. In one or more embodiments, the depth of the depression 36 can be sufficient to submerge at least the bottom surface 42 of the depression 36 within the fluid product F, or sufficient to submerge at least some of the multiplicity of aeration openings 34 within the fluid product F, when assembled, filled, and upright. Alternatively, the depression 36 can be made sufficiently shallow to avoid submersion of one or both of at least some of the multiplicity of aeration openings 34 and the bottom surface 42.

The cryogenic additive isolation portion 22 includes a cryogenic additive holding concavity 28 formed in the cryogenic additive tray 26, which is stamped into the cryogenic additive tray 26, where the cryogenic additive holding concavity 28 can occupy the entire area of the cryogenic additive tray 26 and/or can occupy the entire area of the cryogenic additive isolation portion 22. Here, the cryogenic additive holding concavity 28 is an arc-shaped depression. In one or more embodiments, the volume and shape of the cryogenic additive holding concavity 28 is formed to hold and isolate a specific quantity of cryogenic additive A that is deposited into the cryogenic additive holding concavity 28. The area is configured to catch and retain the dose of cryogenic additive A, which may be deposited in differing regions of the cryogenic additive holding concavity 28, depending on the precision of the cryogenic dosing nozzle. The depth of the cryogenic additive holding concavity 28 is sufficient to prevent travel of the cryogenic additive A outside the cryogenic additive holding concavity 28 when rapidly moving due to the Leidenfrost effect. Further, other portions of the insert 20 can help to protect the inner wall 214 lining from small droplets of cryogenic additive A that may be ejected from the cryogenic additive holding concavity 28, such as the flange 30 or even the aeration portion 24.

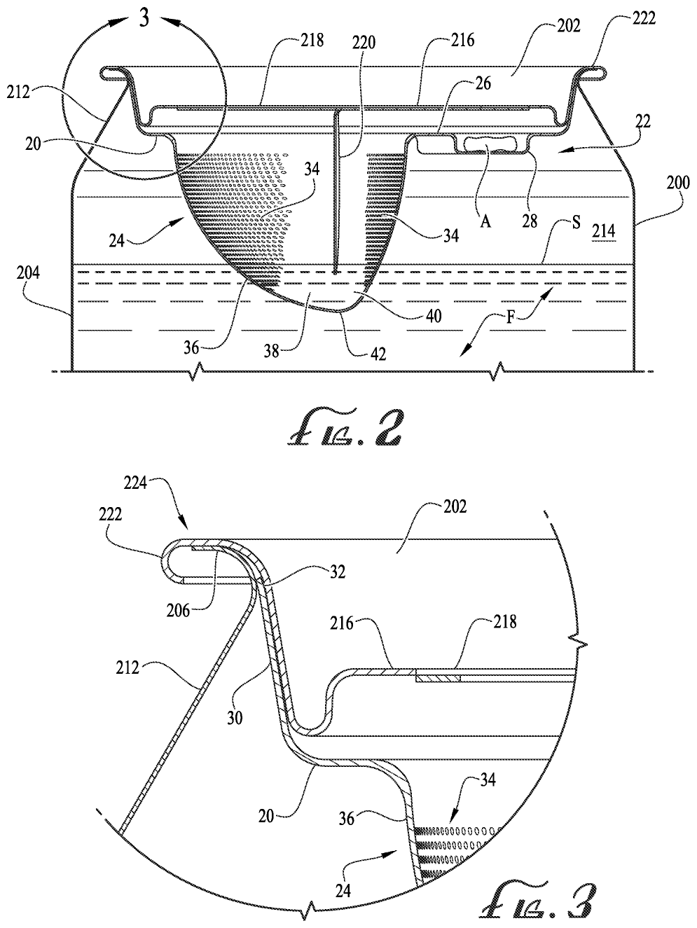

FIGS. 2 and 3 illustrate how the upper edge 32 of the flange 30 is sandwiched or positioned between the rim 206 of the container 200 and the flange 222 of the lid 202, after a known sealing process, such as use of a seaming chuck and seaming roll to create a double seam with sealing compound between the rolls. The upper edge 32 of the flange 30 can be included in the resulting seam (i.e., rolled and sealed within the seam) or merely supported by a portion of the container 200 or a portion of the lid 202.

In use, the fluid product F can be deposited into the interior 208 of the container 200, then the insert 20 can be emplaced within the opening 210 of the container 200 (or vice versa). The fluid product F surface S level can be above or below the bottom surface 42 of the depression 36, depending on the requirements of the particular process. The cryogenic additive A is deposited into the cryogenic additive holding concavity 28 of the cryogenic additive tray 26, where the cryogenic additive A immediately begin to evaporate or boil (in the case where the cryogenic additive A is liquid nitrogen) to displace at least some of the oxygen within the head region above the fluid product F. Within seconds, the lid 202 is dropped onto the container 200 with the insert 20 trapped therebetween, and is sealed to the container 200 as described above. The multiplicity of aeration openings 34 permit the pressure of the nitrogen gas emitted from the cryogenic additive A to equalized throughout the head region. Shortly thereafter, the cryogenic additive A will be completely evaporated; and, in one or more embodiments, all or part of the cryogenic additive isolation portion 22 will have served its purpose and may not serve any further purpose. Once the container 200 is opened by the end user, all or part of the fluid product F will travel through at least some the multiplicity of aeration openings 34 of the aeration portion 24 when poured out of the opening 218 of the lid 202, aerating the fluid product F as the fluid product F travels through each opening of the multiplicity of aeration openings 34. The multiplicity of aeration openings 34 divides fluid product F into many individual streams, thus exposing a large area of the fluid product F to the air for more efficient and greater aeration.

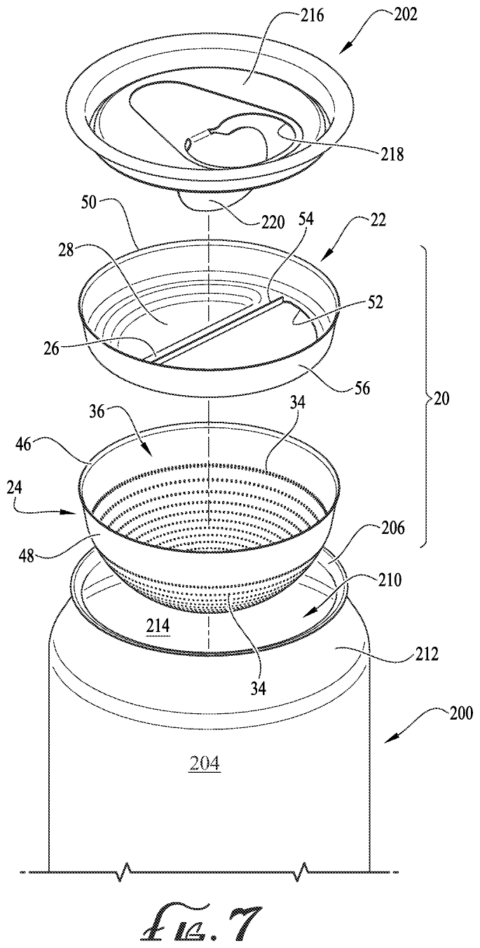

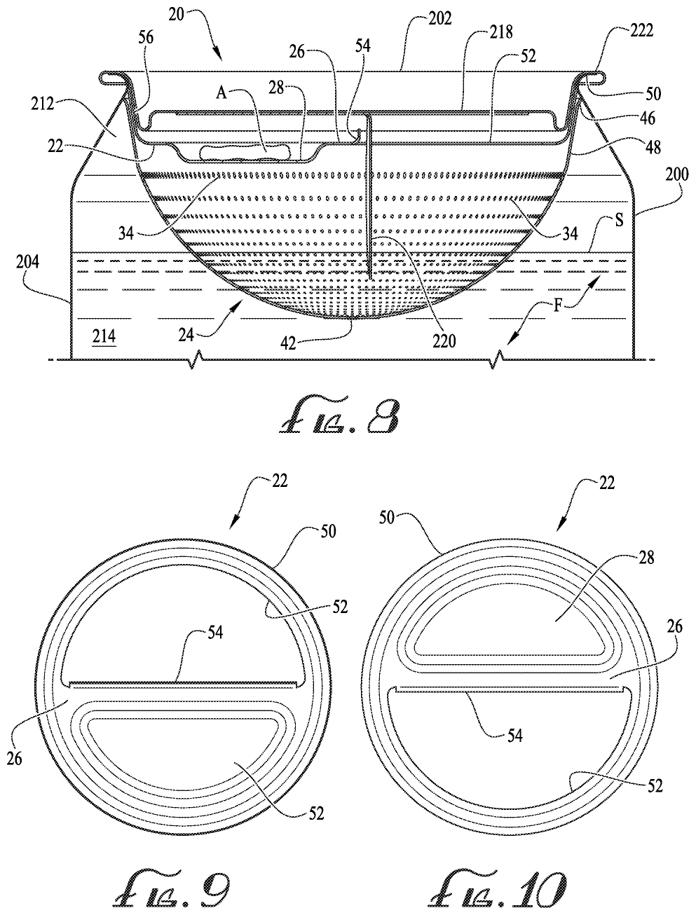

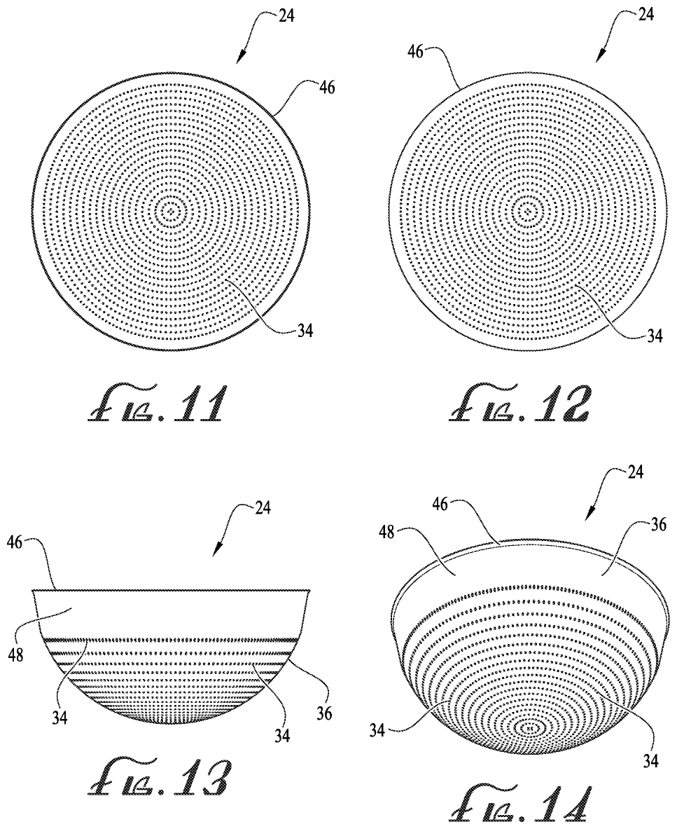

Now turning to the embodiment of FIGS. 7-14, the aeration portion 24 (or bowl in this case) and the cryogenic additive isolation portion 22 (or a tray in this case) are shown as an insert 20 assembly, made of two separate parts stamped out of metal or formed from other appropriate materials. Although the cryogenic additive isolation portion 22 and the aeration portion 24 are shown as an assembly, each can operate and function without the other. For example, the cryogenic additive isolation portion 22 can comprise the entire insert 20 and be installed in the container 200 without the aeration portion 24 when aeration is not required or wanted (such as when the fluid product F is tomato juice or the like). And, similarly, the aeration portion 24 can be installed within the container 200 without the cryogenic additive isolation portion 22, in the case when a cryogenic additive A is not used or when the container 200 is not susceptible to cryogenic damage. All or part of one or both of the cryogenic additive isolation portion 22 and the aeration portion 24 can be treated with spray-coated epoxy lacquer, anodized, or the like to prevent interaction between the cryogenic additive A and the aluminum material.

Looking first at the cryogenic additive isolation tray 22, it includes a cryogenic additive tray 26 having an opening 52 formed therethrough and a cryogenic additive holding concavity 28 formed on the cryogenic additive isolation tray 22 (where, in this example embodiment, a depression is formed into the cryogenic additive isolation tray 22 on the top side of the cryogenic additive isolation tray 22 opposite the fluid). The cryogenic additive holding concavity 28 may be integrally formed with the cryogenic additive isolation tray 22 or attached thereto or even formed without a substantial panel or tray structure. For example, the cryogenic additive holding concavity 28 could be suspended over the fluid product F contained in the container 200 by one or more wires, straps, strips, beams (i.e., material formed or folded to resist substantial bending under expected loads), a cantilevered structure, or even a floating structure, or the like. The cryogenic additive isolation tray 22 further includes a flange or collar 56 forming an annular wall about the cryogenic additive isolation tray 22.

The opening 52 permits fluid communication between an upper chamber (which is defined between the top wall 216 of the lid 202 and the cryogenic additive isolation tray 22) and the contained fluid product F, to permit pouring of the beverage out of the opening 218, to permit an oxygen displacing gas to travel to the fluid product during evaporation of the cryogenic additive A, and/or to permit displaced oxygen to travel toward the lid 202, and/or to permit pressure equalization throughout the interior 208, and/or and to permit oxygen to interact with the fluid product F during pouring to enhance the flavor of the fluid product F (e.g., wine). When assembled to the container 200, the cryogenic additive isolation tray 22 is configured to be arranged within the interior space 208, further defined between the container 200 and the lid 202, held planar perpendicular to the cylindrical axis of the cylindrical container 200 (i.e, such that the cryogenic additive isolation tray 22, or portion thereof, is level with the ground during filling).

The aerator portion 24 is, in this example embodiment, a hemispherically shaped panel that includes one or more (i.e., a plurality or multiplicity) openings or perforations 34 to permit one or both of oxygen laden air and the fluid product F to travel therethrough. Referring to this embodiment and the prior embodiment, the multiplicity of perforations 34 may be arranged in a pattern, such as a concentric annular pattern, radial array, or the like. The multiplicity of perforations 34 can also be randomly arranged on the aerator portion 24. In at least one embodiment, area of each of the perforations 34 are relatively small compared to the total area of the aerator portion 24 (e.g., the surface area of the hemisphere or bowl); for example, less than 1/10 the area of the aerator portion 24 area, or less than 1/20 the area of the aerator portion 24 area, or less than 1/50 the area of the aerator portion 24 area, or less than 1/100 the area of the aerator portion 24 area. The spaces that separate each of the perforations 34 from the neighboring perforations 34 provides opportunity for air to circulate between perforations 34 as streams of fluid are poured through the perforations 34 as the container 200 is tipped for pouring into a separate container.

The hemispherical shape of the aerator portion 24 is configured to provide clearance for the tab 220 as it is pried open. However, the shape of the aerator portion 24 can vary according to design requirements, and can be completely planar, partially planar and partially concave. Clearance may not be required in the form of a concavity, if the aerator portion 24 is positioned sufficiently below the furthest reach of the tab 220; or if the aerator portion 24 is not positioned beneath the tab 220. Additionally, clearance may not be required if part or all of the aerator portion 24 is made of a flexible or otherwise deformable material (such as a thin plastic sheet or mesh or the like), which deflects as the tab 220 is forced open by the user, with the tab 220 itself deforming the aerator portion 24 through contact.

Further, in one or more embodiments, the aerator portion 24 includes an annular collar 48 with a flared upper edge 46 shaped complementarily to the flange 56 of the cryogenic additive isolation tray 22 with a flared upper edge 50, where each include a similar draft angle such that the cryogenic additive isolation tray 22 flange 56 nests within the aerator portion 24 collar 48; and the two nest within the flare of the rim 206, being prevented from falling into the interior 210 due to the draft of collar 48 and/or the flange 46 being too large to fit though the rim 206 at least at the largest diameter portion.

The cryogenic additive holding concavity 28 should be sufficiently large to contain most or all of the cryogenic additive A. In one or more embodiments, a wall 54 or dam is formed by bending up a portion of the cryogenic additive tray 26 at the opening 52 to prevent or substantially prevent flow or splatter of the cryogenic additive A into the fluid product F located therebelow. It is undesirable for a substantial quantity of the cryogenic additive A to fall into the fluid product F where the cryogenic additive A is permitted to interact with the container 200 liner wall 214.

The cryogenic additive A can be chosen from a number of appropriate chemicals and/or compositions. One group of additives can include cryogenic materials, such as low temperature materials that change state (e.g., evaporation or sublimation) upon exposure to the higher temperatures within the container 200 and/or the atmosphere. Examples of cryogenic materials include liquid argon and liquid nitrogen. In one example embodiment, liquid argon at a low temperature is deposited on the cryogenic additive isolation tray 22 into the cryogenic additive holding concavity 28. The liquid argon begins to immediately evaporate to gaseous argon upon exposure to room temperature. As the argon evaporates, the canning process is completed, where the lid 202 is sealed to the container 200, with the cryogenic additive isolation tray 22 either sealed between the two, or wedged in place, or floating atop the beverage (e.g., being made of a material which permits flotation or a hollow sheet material), or being simply supported by a portion of the container 200 and/or the lid 202. Once the container 200 is sealed by known processes (i.e., by use of a seaming chuck and seaming roll to create a double seam with sealing compound between the rolls), the liquid argon continues to evaporate, and thereby pressurizing the container 200 interior 210 to approximately 15 to 30 psi. Furthermore, the gaseous argon is heavier than air and thus displaces the oxygen on the surface of the fluid product F, so that, when the can is substantially upright, the inert argon forms a layer atop the fluid product F surface that substantially prevents contact between the fluid product F and the oxygen. In one or more embodiments, multiple additives can be added to the cryogenic additive isolation tray 22 in one or more cryogenic additive holding concavities 28 (or, in some cases, an cryogenic additive holding concavity 28 may not be required for additives that are not in danger of overflowing into the beverage). A second additive may include oxygen absorbing or scavenging materials known in industry.

The container 200 is at least partially filled with the fluid product F, which can include, in a non-limited list of examples, a flowable medium, such as a liquid, a slurry, a liquid with chunks of solid material, and other products which are in a temporary or permanent flowable state, including foods with a liquid component (e.g., soups, meal replacement drinks and shakes, and the like) and nonedible products (e.g., fluid products used in industry).

Aspects of the present specification may also be described as follows:
1. An insert for a container having an interior, an inner wall, and a rim defining an opening, through which the container can be filled with a fluid product and dosed with a cryogenic additive, and a lid configured to be sealed with the rim after filling the container; the insert comprising a cryogenic additive isolation portion having a cryogenic additive tray comprising a cryogenic additive holding concavity, the cryogenic additive holding concavity configured to receive and substantially hold therein a cryogenic additive during the filling process such that the cryogenic additive is supported above the fluid product after filling and with the container substantially upright; an aeration portion having a multiplicity of openings formed therethrough; and a container engagement portion coupled with the cryogenic additive isolation portion and the aeration portion and configured to engage the container to supportively hold the insert within the interior of the container; wherein, during the filling process, the cryogenic additive is permitted to change state to a gas without substantially contacting the inner wall of the container and the fluid product contained therein while the cryogenic additive is at a cryogenic temperature; and wherein, during a pouring process, at least a portion of the fluid product must pass through at least some of the multiplicity of openings through the aeration portion.
2. The insert of embodiment 1 wherein, the cryogenic additive isolation portion and the aeration portion are manufactured from a single sheet of material.
3. The insert of embodiments 1 or 2, wherein the aeration portion is a depression with the multiplicity of openings formed in the single sheet of material, the depression positioned adjacent to the cryogenic additive isolation portion.
4. The insert of any one of embodiments 1-3, wherein the depression is configured to be at least partially submerged in the fluid product after filling and with the container substantially upright.
5. The insert of any one of embodiments 1-4, wherein the depression includes the multiplicity of openings on at least two substantially opposing sides of the depression.
6. The insert of any one of embodiments 1-5, wherein the container engagement portion is a skirt manufactured from the single sheet of material, the skirt configured to extend upwardly toward the rim of the container when fitted therewithin.
7. The insert of any one of embodiments 1-6, wherein the skirt is configured to be attached to a part of the container to hold the cryogenic additive isolation portion above the fluid product after filling and with the container substantially upright.
8. The insert of any one of embodiments 1-7, wherein the part of the container is the rim of the container.
9. The insert of any one of embodiments 1-8, wherein the aeration portion is a depression with the multiplicity of openings, the lid of the container includes a stay-on tab mechanism with a panel that is pried open for pouring to extend downward and into the container when the container, the depression being configured to be positioned beneath the stay-on tab mechanism and provide clearance for the panel when extended downward.
10. The insert of any one of embodiments 1-9, wherein the cryogenic additive isolation portion is a first part and the aeration portion is a second part, the first part and the second part are joined to form an assembly.
11. An insert for a container having an interior, an inner wall, and a rim defining an opening, through which the container can be filled with a fluid product and dosed with a cryogenic additive, and a lid configured to be sealed with the rim after filling the container; the insert comprising a cryogenic additive tray having a cryogenic additive holding concavity configured to receive and substantially hold therein a cryogenic additive during the filling process such that the cryogenic additive is isolated from the fluid product after filling and with the container substantially upright and while the cryogenic additive is at the cryogenic temperature; wherein, during the filling process, the cryogenic additive is permitted to change state to a gas without substantially contacting the inner wall of the container while the cryogenic additive is at the cryogenic temperature.
12. The insert of embodiment 11, wherein the cryogenic additive tray further comprises a pressure equalization opening to permit equalization of pressure throughout the interior of the container due to expansion of the gas from the cryogenic additive.
13. The insert of embodiments 11 or 12, wherein a wall extends upwardly between the cryogenic additive holding concavity and the pressure equalization opening, the wall being configured to substantially prevent flow of the cryogenic additive from the cryogenic additive holding concavity to the pressure equalization opening.
14. The insert of any one of embodiments 11-13, wherein the pressure equalization opening is configured to be positioned beneath the stay-on tab mechanism and provide clearance for the panel when extended downward.
15. The insert of any one of embodiments 11-14, further comprising a container engagement portion coupled with the cryogenic additive tray and configured to engage the container to supportively hold the insert within the interior of the container.
16. The insert of any one of embodiments 11-15, further comprising an aeration portion having a multiplicity of openings formed therethrough, during a pouring process, at least a portion of the fluid product must pass through at least some of the multiplicity of openings through the aeration portion.
17. The insert of any one of embodiments 11-16, wherein the cryogenic additive tray is a first part and the aeration portion is a second part, the first part and the second part are joined to form an assembly.
18. A method of filling a container with a fluid product, the method comprising providing an insert comprising a cryogenic additive holding concavity; filling the container with the fluid product; emplacing the insert into the container though a container opening defining a container rim; introducing a quantity of a cryogenic additive into the container to be held in substantial isolation within the cryogenic additive holding concavity; sealing the container by placing a lid on the rim of the container to seal the opening; and permitting the cryogenic additive to change phase to a gas without substantially contacting the inner wall of the container while the cryogenic additive is at the cryogenic temperature.
19. The method of embodiment 18, wherein further comprising an aeration portion having a multiplicity of openings formed therethrough, during a pouring process, at least a portion of the fluid product must pass through at least some of the multiplicity of openings through the aeration portion.
20. The insert of embodiments 18-19, wherein wherein the cryogenic additive tray is a first part and the aeration portion is a second part, the first part and the second part are joined to form an assembly.

In closing, it is to be understood that, although aspects of the present specification are highlighted by referring to specific embodiments, one skilled in the art will readily appreciate that these disclosed embodiments are only illustrative of the principles of the subject matter disclosed herein. The specific embodiments are not intended to be exhaustive or to limit the invention to the precise forms disclosed. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the scope of the invention is not to be limited by this detailed description. Furthermore, it is intended that the following appended claims and claims hereafter introduced are interpreted to include all such changes, modifications, permutations, alterations, additions, subtractions and sub-combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified, thus fulfilling the written description of all Markush groups used in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/− 0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as, e.g., “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising”, variations thereof such as, e.g., “comprise” and “comprises”, and equivalent open-ended transitional phrases thereof like “including,” “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement and support for the phrases “consisting essentially of” and “consisting of.”

All patents, patent publications, and other references cited and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

Lastly, the terminology used herein is for the purpose of describing particular embodiments only and is not intended to limit the scope of the present invention, which is defined solely by the claims. Accordingly, the present invention is not limited to that precisely as shown and described.

What is Claimed is:

1) An insert for a container having an interior, an inner wall, and a rim defining an opening, through which the container can be filled with a fluid product and dosed with a cryogenic additive, and a lid configured to be sealed with the rim after filling the container; the insert comprising:
a cryogenic additive isolation portion having a cryogenic additive tray comprising a cryogenic additive holding concavity, the cryogenic additive holding concavity configured to receive and substantially hold therein a cryogenic additive during the filling process such that the cryogenic additive is supported above the fluid product after filling and with the container substantially upright;
an aeration portion having a multiplicity of openings formed therethrough; and
a container engagement portion coupled with the cryogenic additive isolation portion and the aeration portion and configured to engage the container to supportively hold the insert within the interior of the container;
wherein, during the filling process, the cryogenic additive is permitted to change state to a gas without substantially contacting the inner wall of the container and the fluid product contained therein while the cryogenic additive is at a cryogenic temperature;
and wherein, during a pouring process, at least a portion of the fluid product must pass through at least some of the multiplicity of openings through the aeration portion.

2) The insert of claim 1 wherein the cryogenic additive isolation portion and the aeration portion are manufactured from a single sheet of material.

3) The insert of claim 2 wherein the aeration portion is a depression with the multiplicity of openings formed in the single sheet of material, the depression positioned adjacent to the cryogenic additive isolation portion.

4) The insert of claim 3 wherein the depression is configured to be at least partially submerged in the fluid product after filling and with the container substantially upright.

5) The insert of claim 3 wherein the depression includes the multiplicity of openings on at least two substantially opposing sides of the depression.

6) The insert of claim 2 wherein the container engagement portion is a skirt manufactured from the single sheet of material, the skirt configured to extend upwardly toward the rim of the container when fitted therewithin.

7) The insert of claim 6 wherein the skirt is configured to be attached to a part of the container to hold the cryogenic additive isolation portion above the fluid product after filling and with the container substantially upright.

8) The insert of claim 7 wherein the part of the container is the rim of the container.

9) The insert of claim 1 wherein the aeration portion is a depression with the multiplicity of openings, the lid of the container includes a stay-on tab mechanism with a panel that is pried open for pouring to extend downward and into the container when the container, the depression being configured to be positioned beneath the stay-on tab mechanism and provide clearance for the panel when extended downward.

10) The insert of claim 1 wherein the cryogenic additive isolation portion is a first part and the aeration portion is a second part, the first part and the second part are joined to form an assembly.

11) An insert for a container having an interior, an inner wall, and a rim defining an opening, through which the container can be filled with a fluid product and dosed with a cryogenic additive, and a lid configured to be sealed with the rim after filling the container; the insert comprising:
a cryogenic additive tray having a cryogenic additive holding concavity configured to receive and substantially hold therein a cryogenic additive during the filling process such that the cryogenic additive is isolated from the inner wall of the container and is isolated from the fluid product after filling and with the container substantially upright and while the cryogenic additive is at the cryogenic temperature;
wherein, during the filling process, the cryogenic additive is permitted to change state to a gas without substantially contacting the inner wall of the container while the cryogenic additive is at the cryogenic temperature.

12) The insert of claim 11 wherein the cryogenic additive tray further comprises a pressure equalization opening to permit equalization of pressure throughout the interior of the container due to expansion of the gas from the cryogenic additive.

13) The insert of claim 12 wherein a wall extends upwardly between the cryogenic additive holding concavity and the pressure equalization opening, the wall being configured to substantially prevent flow of the cryogenic additive from the cryogenic additive holding concavity to the pressure equalization opening.

14) The insert of claim 12 wherein the pressure equalization opening is configured to be positioned beneath the stay-on tab mechanism and provide clearance for the panel when extended downward.

15) The insert of claim 11 further comprising a container engagement portion coupled with the cryogenic additive tray and configured to engage the container to supportively hold the insert within the interior of the container.

16) The insert of claim 11 further comprising an aeration portion having a multiplicity of openings formed therethrough, during a pouring process, at least a portion of the fluid product must pass through at least some of the multiplicity of openings through the aeration portion.

17) The insert of claim 16 wherein the cryogenic additive tray is a first part and the aeration portion is a second part, the first part and the second part are joined to form an assembly.

18) A method of filling a container with a fluid product, the method comprising:
providing an insert comprising a cryogenic additive holding concavity;
filling the container with the fluid product;
emplacing the insert into the container though a container opening defining a container rim;
introducing a quantity of a cryogenic additive into the container to be held in substantial isolation within the cryogenic additive holding concavity;
sealing the container by placing a lid on the rim of the container to seal the opening; and
permitting the cryogenic additive to change phase to a gas without substantially contacting the inner wall of the container while the cryogenic additive is at the cryogenic temperature.

19) The method of claim 18 further comprising an aeration portion having a multiplicity of openings formed therethrough, during a pouring process, at least a portion of the fluid product must pass through at least some of the multiplicity of openings through the aeration portion.

20) The insert of claim 19 wherein the cryogenic additive tray is a first part and the aeration portion is a second part, the first part and the second part are joined to form an assembly.
